(19) United States
(12) Patent Application Publication
(10) Pub. No.: US 2005/0020473 A1
(43) Pub. Date: Jan. 27, 2005

(54) Liquid all-purposes cleaners

(76) Inventors: Manlio Gallotti, Sao Paulo (BR); George Nunes, Santos-SP (BR); Marcelo Andrade Da Luz, Sao Paulo (BR)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/297,575

(22) PCT Filed: Jun. 6, 2001
(86) PCT No.: PCT/EP01/06403

(30) Foreign Application Priority Data
Jun. 9, 2000 (EP) 00112375.1

(51) Int. Cl. C11D 1/00

(52) U.S. Cl. 510/499

(57) ABSTRACT

The invention relates to a liquid all-purpose cleaning composition that is suitable for cleaning hard surfaces such as plastic, vitreous, metal, and glass. The liquid all-purpose cleaner of the present invention comprise an aqueous composition comprising water, non-ionic and/or anionic surfactants, optional amphoteric surfactants, and cationic compounds of the formula: 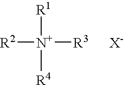
wherein R¹ is C₈-C₂₂-alkyl, C₈-C₂₂-alkenyl, C₈-C₂₂-alkylamidopropyl, C₈-C₂₂-alkenylamidopropyl, C₈-C₂₂-alkyl/alkenyi(poly)alkoxyalkyl, C₈-C₂₂-alkanoylethyl or C₈-C₂₂-alkenoylethyl,
R², R³, and R⁴ are C₁-C₂₂-alkyl, C₂-C₂₂-alkenyl or a group of the formula -A-(OA)ₙ-OH,
A is —C₂H₄— and/or —C₃H₆—, n is a number from 0 to 20 and X is an anion.

This invention relates to liquid all-purpose cleaners suitable for cleaning hard surfaces, which can be employed for household, institutional and/or industrial applications.

Modern cleaners must satisfy high requirements: they must have good detergency toward soiling and grease, good appearance, appropriated viscosity, be environmentally compatible and not leave residues on the surfaces. This invention brings up a new option that besides to fill the bill, to present a high detergency increment when compared with usual cleaner formulations.

The invention provides liquid all-purpose cleaning compositions that are suitable for cleaning hard surfaces such as plastic, vitreous, metal and glass. In general the liquid all-purpose cleaning compositions comprise an aqueous composition containing water, non-ionic and/or anionic surfactants, optionally amphoteric surfactants, and even cationic compounds of the formula 1 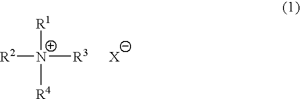
wherein R¹ is C₈-C₂₂-alkyl, C₈-C₂₂-alkenyl, C₈-C₂₂-alkylamidopropyl, C₈-C₂₂-alkenyl-amidopropyl, C₈-C₂₂-alkyl/alkenyl(poly)alkoxyalkyl, C₈-C₂₂-alkanoylethyl or C₈-C₂₂-alkenoylethyl,
R², R³ and R⁴ are C₁-C₂₂-alkyl, C₂-C₂₂-alkenyl or a group of the formula -A-(OA)ₙ-OH,
A is —C₂H₄— and/or —C₃H₆—, n is a number from 0 to 20 and X is an anion.

The non-ionic synthetic organic detergents which are employed in the described compositions are generally the condensation product of an organic aliphatic or alkyl aromatic hydrophobic compound, both saturated or unsaturated, containing a terminal hydroxyl group and hydrophilic ethylene/propylene oxide groups. Such detergents are prepared readily by condensing the hydrophobic organic compound with ethylene/propylene oxide or with the polyhydration product thereof, polyethylene/polypropylene glycol. Further, the length of the polyethenoxy/polypropenoxy chain can be adjusted to achieve the desired balance between the hydrophobic and hydrophilic elements. The satisfactory non-ionic detergents include the condensation products of a higher alkanol containing about 8 to 18 carbon atoms, saturated or unsaturated, in a straight- or branched-chain configuration condensed with about 3 to 30 moles of ethylene/propylene oxide. Examples of these detergents are the condensates of a dodecyl, tridecyl, tetradecyl, hexadecyl alkanol and mixtures thereof with from three to ten moles of ethylene oxide, e.g., condensates of C₉-C₁₁ alkanol with 5.7 moles of ethylene oxide, condensates of C₈-C₁₀ alkanol with 5 moles of ethylene oxide, condensates of C₁₀-C₁₄ alkanol with 6 moles of ethylene oxide and condensates of C₁₀-C₁₈ alkanol with 7 moles of ethylene oxide.

Other satisfactory non-ionic detergents are the polyethylene/polypropylene oxide condensates of one mole of alkyl phenol containing from about 6 to 15 carbon atoms, saturated or unsaturated, in a straight- or branched-chain configuration with about 3 to 30 moles of ethylene/propylene oxide. Specific examples are nonyl phenol condensed with 9 moles of ethylene oxide, nonyl phenol condensed with 12 moles of ethylene oxide, dodecyl phenol condensed with 15 moles of ethylene oxide and dinonyl phenol condensed with 15 moles of ethylene oxide. Further suitable detergents are the water-soluble condensation products of C₈-C₁₈ alkanols with a heteric mixture of ethylene oxide and propylene oxide in a weight ratio of ethylene oxide to propylene oxide in the range of 5:1 to 1:5 with the total alkylene oxide content being 60-85% by weight of the molecule. Specific examples of such detergents are C₉-C₁₁, alkanol condensed with a mixture of 5 moles of ethylene oxide and 4 moles of propylene oxide, C₉-C₁₁ alkanol condensed with 3 moles of ethylene oxide and 2 moles of propylene oxide and the condensation product of C₉-C₁₁ alkanol with a mixture of 4 moles of ethylene oxide and 5 mols of propylene oxide.

Other non-ionic detergents may be alkyldimethyl-amineoxide, di-alkyl-methylamineoxide, alkylamidopropyl-amine oxide, fatty acid-N-methylglucamide, alkylpolyglucoside, oxalkylated fatty acid, oxalkylated fatty acid ester and oxalkylated alkylamine. The alkyl and fatty acid groups of these compounds, which also may be fully or partially replaced by the corresponding unsaturated groups, may contain 8 to 22 carbon atoms and may be linear or branched. Oxalkylated means products that contain preferably 1 to 20 units of ethylene oxide or propyleneoxide or mixtures thereof.

The amount of non-ionic surfactant or mixture of non-ionic surfactants in the claimed compositions is from 0.1 to 40, preferentially from 0.2 to 20% by weight.

Preferred anionic surfactants are linear alkylbenzene sulfonates, olefinsulfonates, alkyl ether sulfates and sec. Alkanesulfonates and its associations. The preferred alkylbenzenesulfonates contain linear chains having from 9 to 25 carbon atoms, preferably from 10 to 13 carbon atoms, the cation is sodium, potassium, ammonium, mono-, di- or triethanolammonium, calcium or magnesium and mixtures thereof. The alkyl group can either be saturated or unsaturated, branched or linear and optionally substituted by a hydroxyl group.

The olefinsulfonates also may contain 9 to 25, preferably 10 to 13 carbon atoms, the cation being the same as for the alkylbenzene sulfonates.

The alkyl ether sulfates used in the compositions according to the invention are water-soluble salts or acids of the formula RO(A)ₘSO₃M, in which R is an unsubstituted C₁₀-C₂₄-alkyl or C₁₀-C₂₄-hydroxyalkyl radical, preferably a C₁₂-C₂₀-alkyl or C₁₂-C₂₀-hydroxyalkyl radical, particularly preferably C₁₂-C₁₈-alkyl or C₁₂-C₁₈-hydroxyalkyl radical. “A” is an ethoxy or propoxy unit, m is a number greater than 0, preferably between 0.5 and about 6, particularly preferably between about 0.5 and about 3, and M is a hydrogen atom or a cation, such as, for example, a metal cation (e.g. sodium, potassium, lithium, calcium magnesium, etc.), ammonium or a substituted ammonium cations. Specific examples of substituted ammonium cations are methylammonium, dimethylammonium, trimethylammonium, mono-, di- or triethanolammonium and quaternary ammonium cations, such as tetramethylammonium and dimethylpiperidinium cations, and also those derived from alkylamines, such as ethylamine, diethylamine, triethylamine. Examples of these alkyl ether sulfates which may be mentioned are C₁₂-C₁₈-alkyl-polyethoxylate (1.0) sulfate, (C₁₂-C₁₈-E(1.0)M), C₁₂-C₁₄-alkyl polyethoxylate (2.0) sulfate (C₁₂-C₁₄-E(2.0)M), C₁₂-C₁₈-alkyl polyethoxylate (2.25) sulfate (C₁₂-C₁₈-E(2.25)M), C₁₂-C₁₈-alkyl polyethoxylate (3.0) sulfate, (C₁₂-C₁₈-E(3.0)M), C₁₂-C₁₈-alkyl polyethoxylate (4.0) sulfate (C₁₂-C₁₈-E (4.0)M).

In the case of the secondary alkanesulfonates, the alkyl group can either be saturated or unsaturated, branched or linear, and optionally substituted by a hydroxyl group. The sulfo group is distributed randomly over the entire carbon chain, where the primary methyl groups on the start of the chain and on the end of the chain do not have sulfonate groups. Preferred secondary alkanesulfonates contain linear alkyl chains having from 9 to 25 carbon atoms, preferably from 10 to 20 carbon atoms and particularly preferably from 13 to 17 carbon atoms. The cation is sodium, potassium, ammonium, mono-, di- or triethanolammonium, calcium or magnesium and mixtures thereof. For the sake of simplicity, sodium is preferred as cation.

In addition to or instead of these preferred anionic surfactants, the all-purpose cleaners forrmulations according to the invention can also comprise other types of anionic surfactants within the limits given above, such as, for example, alkylsulfates, -carboxylates,
phosphates and mixtures of said compounds. Suitable cations are, for example, sodium, potassium, calcium or magnesium, and also ammonium, substituted ammonium compounds, including mono-, di- or triethanolammonium cations, and also mixtures of these cations. The anionic surfactants which are suitable for the present invention have surfactant properties and are water-soluble or water-dispersible.

Alkylsulfates are water-soluble salts or acids of the formula ROSO₃M, in which R is preferably a C₁₀-C₂₄-hydrocarbon radical, preferably an alkyl or hydroxyalkyl radical having C₁₀-C₂₀-alkyl components, particularly preferably a C₁₂-C₁₈-alkyl or hydroxyalkyl radical. M is hydrogen or a cation, e.g. sodium, potassium, lithium or ammonium or substituted ammonium, e.g. methyl-, dimethyl- and trimethylammonium cations and quaternary ammonium cations, such as tetramethylammonium and dimethylpiperidinium cations and quaternary ammonium cations derived from alkylamines, such as ethylamine, diethylamine, triethylamine and mixtures thereof. Instead of alkylsulfates also the corresponding alkenylsulfates may be used or sulfates with mixed alkyl/alkenyl groups.

Other suitable anionic surfactants are carboxylates, e.g. fatty acid soaps and comparable surfactants. These soaps can be saturated or unsaturated and can contain various substituents, such as hydroxyl groups or alpha-sulfonate groups. Preference is given to linear saturated or unsaturated hydrocarbon radicals as hydrophobic component in the soaps. Usually, the hydrophobic components contain from 6 to 30 carbon atoms, preferably from 10 to 18 carbon atoms. Other anionic surfactants are salts of acylaminocarboxylic acids, which are formed by reaction of fatty acid chlorides with sodium sarcosinate in alkaline medium (acyl sarcosinates) and also fatty acid protein condensation products, which are obtained by reaction of fatty acid chlorides with oligopeptides. The salts of alkylsulfamidocarboxylic acids and the salts of alkyl and alkylaryl ether carboxylic acids also have surfactant character.

Other anionic surfactants which are useful for use in detergents and cleaners are sulfonated polycarboxylic acids prepared by sulfonation of the pyrrolysis products of alkaline earth metal citrates, as described, for example, in GB 1 082 179, alkyl glycerol sulfates, fatty acyl glycerol sulfates, oleyl glycerol sulfates, alkylphenol ether sulfates, primary paraffinsulfonates, alkylphosphates, alkyl ether phosphates, isethionates, such as acylisethionates, N-acyltaurides, alkylsuccinamates, sulfosuccinates, monoesters of the sulfosuccinates (particularly saturated and unsaturated C₁₂-C₁₈-monoesters) and diesters of sulfosuccinates (particularly saturated and unsaturated C₁₂-C₁₈-diesters), acylsarcosinates, sulfates of alkylpolysaccharides such as sulfates of alkylglycosides, branched primary alkylsulfates and alkylpolyethoxycarboxylates, such as those of the formula RO(CH₂CH₂)ₖCH₂COO⁻M⁺ in which R is a C₈-C₂₂-alkyl, k is a number from 0 to 10 and M is a cation which forms a soluble salt. Resin acids or hydrogenated resin acids, such as rosin or hydrogenated rosin or tall oil resins and tall oil resin acids can likewise be used. Other examples are described in “Surface Active Agents and Detergents” (Vol. I and 11, Schwartz, Perry and Berch). A large number of such surfactants are also described in U.S. Pat. No. 3,929,678.

Typical examples of anionic surfactants are also alkyl ether sulfonates, glycerol ether sulfonates, sulfofatty acids, fatty alcohol ether sulfates, glycerol ether sulfates, hydroxyl-mixed ether sulfate, fatty acid amide (ether) sulfates, mono- and dialkylsulfosuccinates, mono- and dialkylsulfosuccinamates, sulfotriglycerides, amide soaps, alkyloligoglucosidesulfates, alkylamino sugar sulfates and alkyl (ether) phosphates. If the anionic surfactants contain polyglycol ether chains, they can have a conventional or else a narrowed homologue distribution.

The amount of anionic surfactant or mixture of anionic surfactants in the claimed compositions is from 0.1 to 30, preferentially from 0.2 to 20% by weight.

As cationic surfactants of the formula 1 there may be used the following ones, alkyldimethyl-hydroxyethyl-ammonium, alkyl-dimethyl(poly)alkoxyalkyl-ammonium, alkyltrimethyl-ammonium, dialkyldimethyl-ammonium, dialkyl-methyl(poly)-alkoxyalkyl-ammonium, alkyl-di(poly)-alkoxyalkyl-methyl-ammonium, dialkyl-di(poly)alkoxy-ammonium, alkyl-tri(poly)-alkoxy-ammonium, alkylamidopropyl-trimethyl-ammonium, alkylamidopropyl-dimethyl(poly)-alkoxyalkyl-ammonium, alkoxyethyl-trimethyl-ammonium. Instead of alkyl these ammonium compounds may also have alkenyl groups or mixtures of both. The alkyl as well as the alkenyl groups may contain 8 to 22 carbon atoms. They may be linear or branched. (Poly)alkoxyalkyl means a group of the formula -A-(OA)ₙ-OH wherein A is ethylene or propylene group or a mixture of both and n is a number of from 0 to 20. Preferably n is zero and A is ethylene that means those compounds and preferred which contain a hydroxyethyl group. Most preferred ammonium compounds are C₈-C₂₂-alkyl- or alkenyl-dimethyl-hydroxyethyl-ammonium compounds. All mentioned ammonium compounds may contain any kind of anion, the preferred ones are chloride, bromide, acetate, lactate, sulfate or methosulfate.

The claimed compositions may contain these ammonium compounds in an amount from 0.01 to 30, preferably from 0.02 to 20% by weight.

Furthermore, the compositions according to the invention may contain 0.1 to 20, preferably 0.2 to 15% by weight of amphoteric surfactants. The amphoteric surfactants may be alkyl amidopropyl betaines, alkyl dimethyl betaines, alkyl amphoacetates or -diacetates. The alkyl groups of these compounds, which may be partially or fully replaced by alkenyl groups, may contain 8 to 22 carbon atoms and may be linear or branched. The polyalkylene glycol groups may contain 1 to 20 ethoxy and/or propoxy units.

Depending on the intended use, the formulations according to the invention comprise, in addition to said surfactants and water, additives and auxiliaries which are customary and specific in each case, for example solvents, builders, salts, solubilizers, enzymes, thickeners, preservatives, fragrances and dyes, pearlizing agents, emulsifiers and sequestering agents.

Suitable organic and inorganic builders are neutral or, in particular, alkaline salts which are able to precipitate out calcium ions or bind calcium ions to form a complex. Suitable and particularly ecologically acceptable builder substances, such as finely crystalline, synthetic hydrous zeolites preferably the type NaA, which have a calcium-binding capacity in the range from 100 to 200 mg of CaO/g, are used in preference. Zeolite and phyllosilicates can be present in the composition in an amount up to 20% by weight. Organic builders which can be used are, for example, the percarboxylic acids preferably used in the form of their sodium salts, such as citric acid and nitriloacetate (NTA), ethylenediaminetetraacetic acid, provided such a use is not objectionable for ecological reasons. Analogous thereto, it is also possible to use polymeric carboxylates and salts thereof. These include, for example, the salts of homopolymeric or copolymeric polyacrylates, polymethylacrylates and in particular, copolymers of acrylic acid with maleic acid, and also polyvinylpyrrolidone and urethanes. The relative molecular mass of the homopolymers is generally between 1000 and 100,000, that of the copolymers is between 2000 and 200,000, preferably 50,000 to 120,000, based on the free acid, in particular water-soluble polyacrylates which have been crosslinked, for example, with approximately 1% of a sugar polyallyl ether and which have a relative molecular mass above one million are also suitable. Examples thereof are the polymers obtainable under the name Carbopole® 940 and 941. The crosslinked polyacrylates are used in amounts not exceeding 1% by weight, preferably in amounts of from 0.2 to 0.7% by weight. The builder substances can be used in amounts up to 5% by weight.

The desired viscosity of the compositions is adjusted by adding water and/or organic solvents, or by adding a combination of organic solvents and thickeners.

In principle, suitable organic solvents are any mono- or polyhydric alcohols. Preference is given to using alcohols having from 1 to 4 carbon atoms, such as methanol, ethanol, propanol, isopropanol, straight chain and branched butanol, glycerol and mixtures of said alcohols. Other preferred alcohols are polyethylene glycols having a relative molecular mass below 2000. In particular, the use of polyethylene glycol having a relative molecular mass between 200 and 600 and in amounts up to 45% by weight, and of polyethylene glycol having a relative molecular mass between 400 and 600 in amounts from 5 to 25% by weight is preferred. Also the lower alkyl ether of ethylenglycol, propylenglycol, polyethylenglycol and polypropylenglycol can be used. An advantageous mixture of solvents consists of a monomeric alcohol, for example ethanol and polyethylene glycol in the ratio 0.5:1 to 1.2:1.

Other suitable solvents are, for example, triacetin (glycerol triacetate) and 1-methoxy-2-propanol.

Preferred thickeners are hydrogenated castor oil, salts of long-chain fatty acids, which are preferably used in amounts of from 0 to 5% by weight and in particular in amounts from 0.5 to 2% by weight, for example sodium, potassium, aluminium, magnesium and titanium stearates or the sodium and/or potassium salts of behenic acid, and polysaccharides, in particular xanthan gum, guar guar, agar agar, alginates and tyloses, carboxymethylcellulose and hydroxyethylcellulose, and also relatively high molecular weight polyethylene glycol mono- and -diesters of fatty acids, polyacrylates, polyvinyl alcohol and polyvinylpyrrolidone, and also electrolytes such as sodium chloride and ammonium chloride

Suitable enzymes are those from the class of proteases, lipases, amylases and their mixture. Their proportion can be from 0.2 to 1% by weight. The enzymes can be adsorbed to carrier substances and/or embedded into coating substances.

Suitable preservatives are, for example, phenoxyethanol, formaldehyde solution, pentanediol or sorbic acid.

Suitable pearlizing agents are, for example, glycerol distearic esters such as ethylene glycol distearate, but also fatty acid monoglycol esters.

Suitable salts or extenders are, for example, sodium sulfate, sodium carbonate, ammonium chloride, magnesium chloride, sodium chloride, sodium tripolyphosphate, sodium silicate (water glass) or magnesium sulfate.

Typical individual examples of other additives are sodium borate, starch, sucrose, polydextrose, RAED, stilbene compounds, methylcellulose, toluenesulfonate, cumenesulfonate, soaps and silicones.

The products according to the invention are notable for very good storage stability and also detergency.

The examples below serve to illustrate the invention in more detail without limiting it thereto. All amounts are given as % (w/w).

### EXAMPLES

I) All-Purpose Cleaner

A) 1.50 C₁₀/C₁₈-Fatty alcohol with 7 moles of ethylene oxide (100% a.m.) (Genapol C070®)

B) 1.40 C₁₂/C₁₄-Alkyl dimethyl hydroxyethyl ammonium chloride (40% a.m.) (Praepagen HY®)

C) 1.00 Sodium Tripolyphosphate

D) Water qsp 100

E) Perfume qs

F) Colorant qds

G) Preservant qs

Procedure:

I. Mix at room temperature C+D

II. Add A and mix

III. Add B and mix

IV: Add E, F & G and mix

II) All-Purpose Cleaner

A) 3.20 Ethoxylated alkyl amine (100% a.m.) (Genamin T120®)

B) 2.00 C₁₂/C₁₄-Alkyl dimethyl hydroxyethyl ammonium chloride (40% a.m.) (Praepagen HY®)

C) Water qsp 100

D) Perfume qs

E) Colorant qs

F) Preservant qs

Procedure:

I. Mix at room temperature A+C

II. Add B and mix

III. Add D, E & F and mix

III) All-Purpose Cleaner

A) 0.70 C₁₀/C₁₈-Fatty alcohol with 7 moles of ethylene oxide (100% a.m.) (Genapol C070®)

B) 0.5 C₁₂/C₁₄-Alkyl dimethyl hydroxyethyl ammonium chloride (40% a.m.) (Praepagen HY®)

C) 0.50 Propylene glycol n-butyl ether (Dowanol PnB®)

D) Water qsp 100

E) Perfumeqs

F) Colorant qs

G) Preservant qs

Procedure:

I. Mix at room temperature A+D

II. Add Band mix

III. Add C and mix

IV. Add E, F & G and mix

IV) All-Purpose Cleaner

A) 1.6 C₁₀/C₁₈-Fatty alcohol with 7 moles of ethylene oxide (100% a.m.) (Genapol C070®)

B) 1.0 C₁₂/C₁₄-Alkyl dimethyl hydroxyethyl ammonium chloride (40% a.m.) (Praepagen HY®)

C) 3.0 Propylene glycol n-butyl ether (Dowanol PnB®)

D) Water qsp 100

E) Perfume qs

F) Colorant qs

G) Preservant qs

Procedure:

I. Mix at room temperature A+D

II. Add B and mix

III. Add C and mix

IV. Add E, F & G and mix

V) All-Purpose Cleaner

A) 2.6 C₁₄/C₁₇-Sodium sec-alkyl sulfonate (60% a.m.) (Hostapur SAS 60®)

B) 1.0 C₁₂/C₁₄-Alkyl dimethyl hydroxyethyl ammonium chloride (40% a.m.) (Praepagen HY®)

C) 3.0 Propylene glycol n-butyl ether (Dowanol PnB®)

D) Water qsp 100

E) Perfume qs

F) Colorant qs

G) Preservant qs

Procedure:

I. Mix at room temperature A+D

II. Add B and mix

III. Add C and mix

IV. Add E, F & G and mix

VI) All-Purpose Cleaner

A) 0.4 C₁₀/C₁₈-Fatty alcohol with 7 moles of ethylene oxide (100% a.m.) (Genapol C070®)

B) 2.3 C₁₂/C₁₄-Alkyl dimethyl hydroxyethyl ammonium chloride (40% a.m.) (Praepagen HY®)

C) 0.3 C₁₄/C₁₇-Sodium sec-alkyl sulfonate (60% a.m.) (Hostapur SAS 60®)

D) 3.0 Propylene glycol n-butyl ether (Dowanol PnB®)

E) Water qsp 100

F) Perfume qs

G) Colorant qs

H) Preservant qs

Procedure:

I. Mix at room temperature A+E

II. Add C and mix

III. Add B and mix

IV. Add D and mix

IV. Add F, G & H and mix

VII) All-Purpose Cleaner

A) 1.8 Linear alkyl benzene sulphonic acid (96% a.m.)

B) 0.1 C₁₀/C₁₈-Fatty alcohol with 7 moles of ethylene oxide (100% a.m.) (Genapol C070®)

C) 0.2 C₁₂/C₁₄-Alkyl dimethyl hydroxyethyl ammonium chloride (40% a.m.) (Praepagen HY®)

D) 2.3 Sodium hydroxide (sol. 10% w/w)

E) 4.4 Butylglycol

F) 1.4 Ethanol

G) 2.3 Sodium tripolyphosphate

H) 0.7 Sodium carbonate

I) Water qsp 100

J) Perfume qs

K) Colorant qs

L) Preservant qs

Procedure:

I. Mix at room temperature A+D+I

II. Add G+H and mix

III. Add E+F and mix

IV. Add B+C and mix

V. Add J+K+L and mix

VIII) All-Purpose Cleaner

A) 1.8 Linear alkyl benzene sulphonic acid (96%, a.m.)

B) 0.1 Nonil phenol with 9 mols of ethylene oxide (100% a.m.) (Arkopal N090®)

C) 0.2 C₁₂/C₁₄-Alkyl dimethyl hydroxyethyl ammonium chloride (40% a.m.) (Praepagen HY®)

D) 2.3 Sodium hydroxide (sol. 10% w/w)

E) 3.6 Butylglycol

F) 1.2 Ethanol

G) 0.9 Sodium tripolyphosphate

H) 0.8 Sodium carbonate

I) Water qsp 100

J) Perfume qs

K) Colorant qs

L) Preservant qs

Procedure:

I. Mix at room temperature A+D+I

II. Add G+H and mix

III. Add E+F and mix

IV. Add B+C and mix

V. Add J+K+L and mix

IX) All-Purpose Cleaner

A) 2.7 Linear alkyl benzene sulphonic acid (96% a.m.)

B) 0.4 C₁₀/C₁₈-Fatty alcohol with 7 moles of ethylene oxide (100% a.m.) (Genapol C070®)

C) 0.3 C₁₂/C₁₄-Alkyl dimethyl hydroxyethyl ammonium chloride (40% a.m.) (Praepagen HY®)

D) 3.5 Sodium hydroxide (sol. 10% w/w)

E) 4.7 Butylglycol

F) Water qsp 100

G) Perfume qs

H) Colorant qs

I) Preservant qs

Procedure:

I. Mix at room temperature A+D+F

II. Add E and mix

III. Add B+C and mix

IV. Add G+H+l and mix

X) All-Purpose Cleaner

A) 4.8 Sodium laureth 2 sulphate (27% a.m.) (Genapol LRO®)

B) 0.6 C₁₀/C₁₈-Fatty alcohol with 7 moles of ethylene oxide (100% a.m.) (Genapol C070®)

C) 0.7 C₁₂/C₁₄-Alkyl dimethyl hydroxyethyl ammonium chloride (40% a.m.) (Praepagen HY®)

D) 17.6 Sodium hydroxide (sol. 10% w/w)

E) 4.8 Propyleneglycol

F) 0.6 Citric acid

G) Water qsp 100

H) Perfume qs

I) Colorant qs

J) Preservant qs

Procedure:

I. Mix at room temperature A+G

II. Add F and mix

III. Add D and mix

IV. Add E and mix

V. Add B+C and mix

VI. Add H+I+J and mix

1. A liquid all-purpose cleaner comprising water, non-ionic and/or anionic surfactants and cationic compounds of the formula 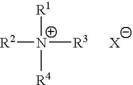
wherein
R¹ is C₈-C₂₂-alkyl, C₈-C₂₂-alkenyl, C₈-C₂₂-alkyl/alkenylamidopropyl, C₈-C₂₂-alkoxyalkenylethyl, C₈-C₂₂-alkyl/alkenyl(poly)alkoxyalkyl, C₈-C₂₂-alkanoylethyl or C₈-C₂₂-alkenoylethyl,
R² is C₁-C₂₂-alkyl, C₂-C₂₂-alkenyl or a group of the formula -A-(OA)ₙ-OH,
R³ and R⁴ are C₁-C₂₂-alkyl, C₂-C₂₁-alkenyl or a group of the formula -A-(OA)ₙ-OH,
A is —C₂H₄— and/or —C₃H₆— and
n is a number from 0 to 20 and
X is an anion.

2. A liquid all-purpose cleaner as claimed in claim 1, wherein the non-ionic surfactant is a condensation product of a C₈-C₁₈-alkanol with 3 to 30 moles of ethylene/propylene oxide or a condensation product of one mole of alkyl phenol containing from 6 to 15 carbon atoms with 3 to 30 moles of ethylene/propylene oxide, or even a mixture thereof.

3. A liquid all-purpose cleaner as claimed in claim 1, wherein the cationic compound is a C₈-C₂₂-alkyl- or C₈-C₂₂-alkenyl-dimethyl-hydroxy-ethyl ammonium compound.

4. A liquid all-purpose cleaner as claimed in claim 1, wherein the non-ionic surfactants are present in an amount of from 0.1 to 40, preferentially from 0.2 to 20% by weight.

5. A liquid all-purpose cleaner as claimed in claim 1, wherein the anionic surfactant are alkylbenzene sulfonates, olefinsulfonates, alkyl sulfates, alkyl ether sulfates or sec. Alkanesulfonates and mixture thereof.

6. A liquid all-purpose cleaner as claimed in claim 1, wherein the anionic surfactants are present in an amount of from 0.1 to 30, preferentially from 0.2 to 20% by weight.

7. A liquid all-purpose cleaner as claimed in claim 1, wherein the cationic compounds is present in an amount of from 0.01 to 30, preferentially from 0.02 to 20% by weight.

8. A liquid all-purpose cleaner as claimed in claim 1, which additionally contains from 0.1 to 20% by weight of one or more amphoteric surfactants.

9. A liquid all-purpose cleaner as claimed in claim 1, which additionally contains one or more solvents, preferentially alcohols or lower alkyl ethers of ethylenglycol, propylenglycol, polyethylenglycol and polypropylenglycol.

10. A liquid all-purpose cleaner as claimed in claim 1, which additionally contains further additives and adjuvants.

11. A liquid all-purpose cleaner as claimed in claim 1, wherein the cationic surfactants also present anti-microbial effects, such as bactericide and/or fungicide.
